(19) United States
(12) Patent Application Publication
(10) Pub. No.: US 2016/0300203 A1
(43) Pub. Date: Oct. 13, 2016

(54) SETTLEMENT SYSTEM, SERVER DEVICE, TERMINAL DEVICE, RECORDING MEDIUM, METHOD AND PROGRAM

(71) Applicant: NEC CORPORATION, Minato-ku, Tokyo (JP)

(72) Inventor: Takeo OHNO, Tokyo (JP)

(21) Appl. No.: 14/379,281

(22) PCT Filed: Aug. 13, 2013
(86) PCT No.: PCT/JP2013/004851

§ 371 Date: Aug. 15, 2014

(51) Int. Cl. G06Q 20/10; G06F 17/30; G06Q 20/34; G06Q 20/36; G06Q 20/20

(52) U.S. Cl. CPC G06Q 20/102; G06Q 20/3676; G06Q 20/204; G06Q 20/349; G06Q 20/3672; G06F 17/30864; G06Q 20/108

(57) ABSTRACT

A terminal device comprising set amount update means for performing a process of reading a time-period-specifying value, which is a value specifying any one of a plurality of time periods, from a recording medium storing the time-period-specifying value and a set amount, which is a value specifying a payable money amount, and if the read time-period-specifying value is specifying a predetermined time period, performing a process of updating the set amount stored in the recording medium and a process of updating the time-period-specifying value stored in the recording medium with a value specifying a time period equal to or later than that immediately following the predetermined time period.

### TECHNICAL FIELD

The present invention relates to a settlement system, a server device, a terminal device, a recording medium, a method and a program, in particular, to them which perform payment off-line.

### BACKGROUND ART

A POS terminal of Patent Document 1 requests a host of a bank to perform a settlement by money transfer between accounts if the payment amount is large, and it performs the settlement with electronic money stored in a card if the payment amount is small. A user charges a card with electronic money by using an electronic money charging machine. The electronic money charging machine converts a money amount designated by the user, out of funds in the user's bank account, into electronic money and stores it into the card.

A cash dispenser of Patent Document 2 converts a point value according to a credit purchase amount, recorded in an IC (Integrated Circuit) card, into money amount information and adds the money amount to the balance of the IC card.

### CITATION LIST

### Patent Document

[Patent Document 1] Japanese Patent Application Laid-Open No. 2000-67140

[Patent Document 2] Japanese Patent Application Laid-Open No. 2003-337925

### SUMMARY OF INVENTION

### Technical Problem

In the system of Patent Document 1, a user needs to manage a remaining amount of electronic money stored in the user's card and deposit electronic money into the card in advance by the use of the electronic money charging machine.

The objective of the present invention is to provide technology for removing such burden on users.

### Solution to Problem

A terminal device according to an exemplary embodiment comprising:

set amount update means for performing a process of reading a time-period-specifying value, which is a value specifying any one of a plurality of time periods, from a recording medium storing the time-period-specifying value and a set amount, which is a value specifying a payable money amount, and

if the read time-period-specifying value is specifying a predetermined time period, performing a process of updating the set amount stored in the recording medium and a process of updating the time-period-specifying value stored in the recording medium with a value specifying a time period equal to or later than that immediately following the predetermined time period.

A server device according to an exemplary embodiment connected to a terminal device:

the terminal device performing

a process of receiving a gray list including an update amount with regard to a recording medium storing a set amount, which is a value specifying a payable money amount, and a time-period-specifying value, which is a value specifying any one of a plurality of time periods, and a process of reading the time-period-specifying value from the recording medium, and

if the read time-period-specifying value is specifying a predetermined time period,

a process of searching the gray list, a process of updating the set amount stored in the recording medium with the update value with regard to the recording medium if the update value is included in the gray list and, if not included, with a predetermined money amount, and a process of updating the time-period-specifying value stored in the recording medium with a value specifying a time period equal to or later than that immediately following the predetermined time period,

the server device comprising list distribution means for performing, in each of the time periods, a process of generating the gray list including the balance of the account, with regard to the recording medium, whose the balance is less than the predetermined money amount, and a process of sending the gray list to the terminal device.

A recording medium according to an exemplary embodiment comprising:

set amount storage means for storing a set amount, which is a value specifying a payable money amount, and

time period storage means for storing a time-period-specifying value, which is a value specifying any one of a plurality of time periods, wherein

if the time-period-specifying value is specifying a predetermined time period, the set amount stored in the recording medium is updated, and the time-period-specifying value stored in the recording medium is updated with a value specifying a time period equal to or later than that immediately following the predetermined time period.

A method according to an exemplary embodiment comprising:

performing a process of reading a time-period-specifying value, which is a value specifying any one of a plurality of time periods, from a recording medium storing the time-period-specifying value and a set amount, which is a value specifying a payable money amount, and

performing, if the read time-period-specifying value is specifying a predetermined time period, a process of updating the set amount stored in the recording medium and a process of updating the time-period-specifying value stored in the recording medium with a value specifying a time period equal to or later than that immediately following the predetermined time period.

A method according to an exemplary embodiment comprising:

performing a process of connecting to a terminal device which performs

a process of receiving a gray list including an update amount with regard to a recording medium storing a set amount, which is a value specifying a payable money amount, and a time-period-specifying value, which is a value specifying any one of a plurality of time periods, and a process of reading the time-period-specifying value from the recording medium, and

if the read time-period-specifying value is specifying a predetermined time period,

performs a process of searching the gray list, a process of updating the set amount stored in the recording medium with the update value with regard to the recording medium if the update value is included in the gray list and, if not included, with a predetermined money amount, and

a process of updating the time-period-specifying value stored in the recording medium with a value specifying a time period equal to or later than that immediately following the predetermined time period, and

performing, in each of the time periods, a process of generating the gray list including the balance of an account, with regard to the recording medium, whose the balance is less than the predetermined money amount, and sending the gray list to the terminal device.

A program according to an exemplary embodiment for causing a computer to execute:

a process of reading a time-period-specifying value, which is a value specifying any one of a plurality of time periods, from a recording medium storing the time-period-specifying value and a set amount, which is a value specifying a payable money amount, and

if the read time-period-specifying value is specifying a predetermined time period, a process of updating the set amount stored in the recording medium and a process of updating the time-period-specifying value stored in the recording medium with a value specifying a time period equal to or later than that immediately following the predetermined time period.

A program according to an exemplary embodiment for causing a computer to execute:

a process of connecting to a terminal device which

performs a process of receiving a gray list including an update amount with regard to a recording medium storing a set amount, which is a value specifying a payable money amount, and a time-period-specifying value, which is a value specifying any one of a plurality of time periods, and a process of reading the time-period-specifying value from the recording medium, and,

if the read time-period-specifying value is specifying a predetermined time period,

performs a process of searching the gray list, a process of updating the set amount stored in the recording medium with the update value with regard to the recording medium if the update value is included in the gray list and, if not included, with a predetermined money amount, and

a process of updating the time-period-specifying value stored in the recording medium with a value specifying a time period equal to or later than that immediately following the predetermined time period, and

in each of the time periods, a process of generating the gray list including the balance of the account, with regard to the recording medium, whose the balance is less than the predetermined money amount, and sending the gray list to the terminal device.

### Advantageous Effects of Invention

The present invention reduces the burden on users associated with charging a card with a payment means such as electronic money.

### BRIEF DESCRIPTION OF THE DRAWINGS

FIG. 1 is a configuration diagram of a settlement system 4 according to a first exemplary embodiment.

FIG. 2 shows a configuration of a gray list stored in a gray list storage unit 13.

FIG. 3 shows information stored in an account storage unit 25.

FIG. 4 is a flow chart of operation of a set amount update unit 12.

FIG. 5 is a flow chart of operation of a terminal processing unit 11.

FIG. 6 is a flow chart of operation in online processing by the terminal processing unit 11.

FIG. 7 is a flow chart of operation of a list distribution unit 21.

FIG. 8 is a flow chart of operation of a server processing unit 22.

FIG. 9 is a flow chart of operation of a general processing unit 23.

FIG. 10 is a configuration diagram of a settlement system 4 according to a fourth exemplary embodiment.

FIG. 11 shows a configuration of a default list stored in a default list storage unit 17.

FIG. 12 shows a configuration of an account record 50 stored in an account storage unit 25 of the fourth exemplary embodiment.

FIG. 13 is a flow chart of operation of a set amount update unit 12 in the fourth exemplary embodiment.

FIG. 14 is a flow chart of operation of a list distribution unit 21 in the fourth exemplary embodiment.

FIG. 15 shows a configuration of a terminal device 1 of a fifth exemplary embodiment.

FIG. 16 shows a configuration of a server device 2 in a sixth exemplary embodiment.

FIG. 17 shows a configuration of an IC card 3 in a seventh exemplary embodiment.

### DESCRIPTION OF EMBODIMENTS

### First Exemplary Embodiment

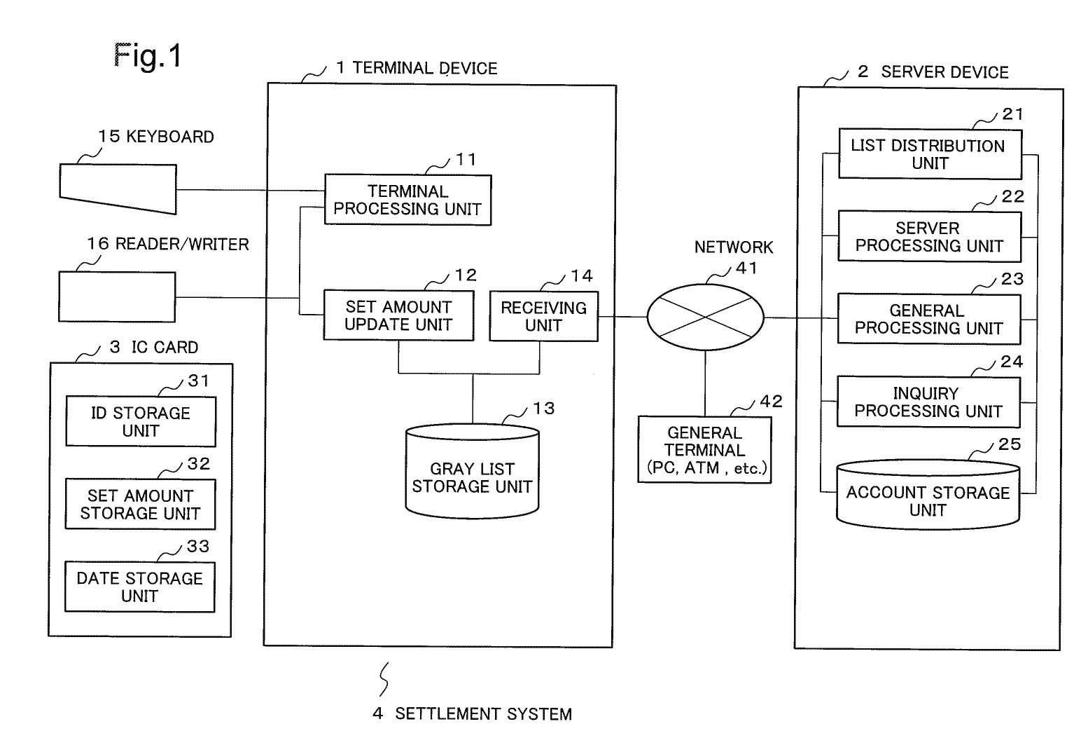

FIG. 1 is a configuration diagram of a settlement system 4 according to the present exemplary embodiment. The settlement system 4 includes a terminal device 1, a general terminal 42 and a server device 2 which are connected with each other via a network 41.

The terminal device 1 is, for example, a device for payment installed at a payment counter in a store. The server device 2 is installed, for example, in a bank. The general terminal 42 is, for example, an ATM (Automated Teller Machine) installed in a bank or a PC (Personal Computer) installed at home. The settlement system 4 performs either off-line settlement or on-line settlement, depending on the amount a user is willing to pay.

In the off-line settlement, the user makes payment with electronic money or the like stored in an IC card 3 he/she carries. In the off-line settlement, the user does not need to wait for completion of communication between the terminal device 1 and the server device 2. In the on-line settlement, the user makes payment out of the balance of his/her bank account stored in the server device 2. In the on-line settlement, the user needs to wait for completion of communication between the terminal device 1 and the server device 2.

The terminal device 1 in the settlement system 4 of the present exemplary embodiment updates the amount of electronic money or the like stored in the IC card 3 once per almost constant time period, for example, once a day, once a week or once a month. Henceforth, the update is assumed to be performed at a frequency of once a day, unless otherwise noted.

The terminal device 1 comprises a terminal processing unit 11, a set amount update unit 12, a gray list storage unit 13 and a receiving unit 14. A keyboard 15 and a reader/writer 16 are connected to the terminal processing unit 11. The reader writer 16 is connected also to the set amount update unit 12.

The terminal processing unit 11 selects between processing for off-line settlement (henceforth, referred to as off-line processing) and processing for on-line settlement (henceforth, referred to as on-line processing), depending on a payment amount inputted from the keyboard 15 or the like, and executes the selected processing. The set amount update unit 12 updates the amount of electronic money or the like stored in the IC card 3. The user possessing the IC card 3 can make settlement off-line within the money amount stored therein. The receiving unit 14 receives a gray list distributed by the server device 2 and stores it into the gray list storage unit 13. The gray list is, for example, a list of bank accounts whose balance is less than a predetermined money amount.

The reader/writer 16 reads and writes data stored in the IC card 3. The reader/writer 16 is, for example, a reader/writer for an RFID (Radio Frequency IDentification).

The IC card 3 comprises an ID storage unit 31 for storing a card ID (IDentification) or a user ID (henceforth, referred to simply as an ID), a set amount storage unit 32 for storing a set amount, which is a value specifying a payable money amount in off-line settlement or the like, and a time period storage unit 33 for storing a time-period-specifying value, which is a value specifying a time period during which update of the set amount was last performed.

The time period storage unit 33 may store any type of value capable of specifying a time period. For example, the time period storage unit 33 stores a date of having updated the set amount (henceforth, referred to as an update date). In a case of storing an update date, the time period storage unit 33 is referred to also as a date storage unit 33. In a case the set amount is updated once a week, the time period storage unit 33 may store, for example, the date of Monday of the week an update date belongs to. In a case the set amount is updated once a month, the time period storage unit 33 may store, for example, the name of a month such as January.

The terminal processing unit 11, the set amount update unit 12 and the receiving unit 13 are constructed using logic circuits or the like. They may also be implemented by software which is stored in a memory (not illustrated) of the terminal device 1 and executed by a processor 19 of the terminal device 1. The gray list storage unit 13 is a storage device such as an IC memory and a disk device.

The server device 2 comprises a list distribution unit 21, a server processing unit 22, a general processing unit 23, an inquiry processing unit 24 and an account storage unit 25. The list distribution unit 21 generates a gray list and sends it to the terminal device 1. The server processing unit 22 performs off-line settlement and on-line settlement in collaboration with the terminal processing unit 11 of the terminal device 1. Receiving a request from the general terminal 42, the general processing unit 23 performs on-line settlement for money transfer to another account, payment for internet shopping or the like, within the balance of an account. Receiving an inquiry about a set amount including an ID from the terminal device 1, the inquiry processing unit 24 sends back the smaller one between the balance of an account corresponding to the ID and a predetermined money amount. The account storage unit 25 stores information on such as user's bank accounts.

The list distribution unit 21, the server processing unit 22, the general processing unit 23 and the inquiry processing unit 24 are constructed using logic circuits or the like. They may also be implemented by software which is stored in a memory (not illustrated) of the server device 2 and executed by a processor 29 of the server device 2. The account storage unit 25 is a storage device such as an IC memory and a disk device.

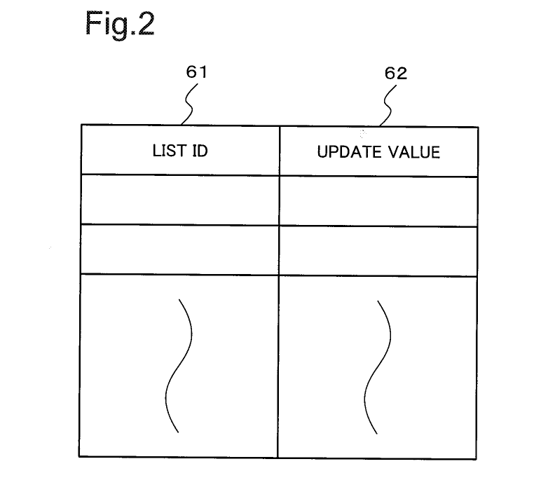

FIG. 2 shows a configuration of a gray list stored in the gray list storage unit 13. The gray list contains a list ID 61 and an update value 62 in a manner to correlate them with each other. For example, the gray list is a list containing the ID of a bank account whose balance is less than a predetermined money amount as a list ID 61, and its balance as an update value 62.

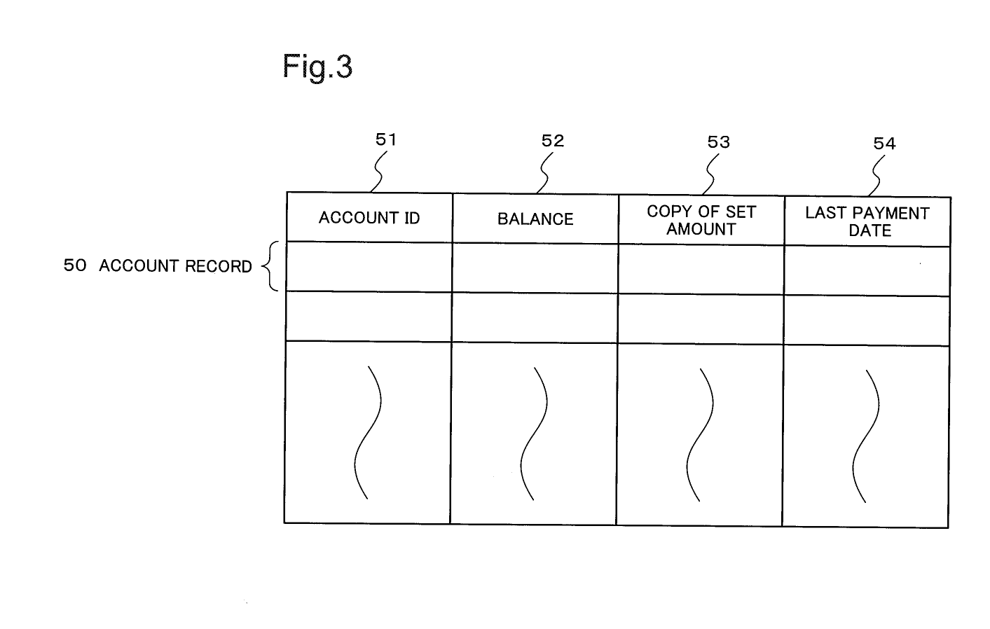

FIG. 3 shows information stored in the account storage unit 25. The account storage unit 25 stores an account record 50 with respect to each of user'sbank accounts. Each account record 50 includes an account ID 51, a balance 52, a copy of set amount 53 and a last payment date 54.

The account ID 51 is of the same value as that of the ID stored in the ID storage unit 31 of an IC card 3 issued to the user of the corresponding account. The balance 52 is the balance of the account. As the copy of set amount 53, recorded is a copy of a set amount stored in the set amount storage unit 32 of the IC card 3 for the account. As the last payment date 54, recorded is the most recent date of the user's having made payment using the IC card 3 for the account.

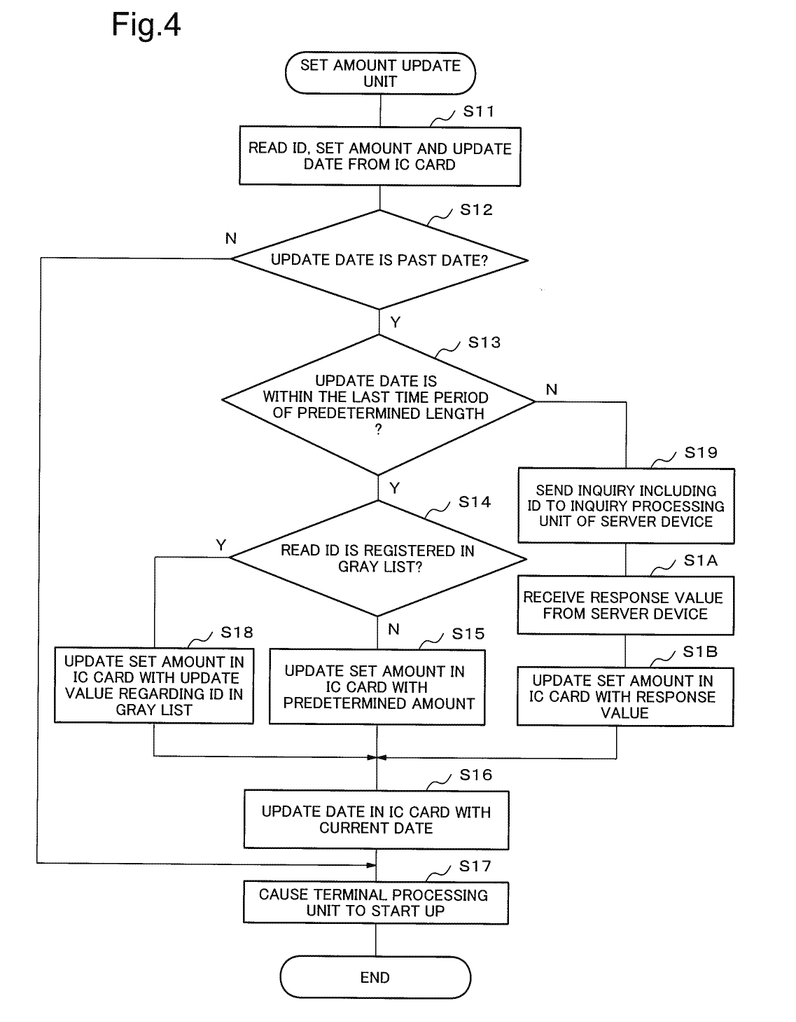

FIG. 4 is a flow chart of operation of the set amount update unit 12. The set amount update unit 12 starts the operation, for example, in response to the reader/writer 16 detecting the IC card 3 when a user holds an IC card 3 over the reader/writer 16. Alternatively, it may start the operation in response to an instruction inputted by a person operating the terminal device 1.

The set amount update unit 12 reads an ID, a set amount and an update date from an IC card 3 (S11). The set amount update unit 12 reads the ID, the set amount and the update date from, respectively, the ID storage unit 31, the set amount storage unit 32 and the date storage unit 33.

The set amount update unit 12 determines whether or not the update date is a past date, for example, a date prior to that of the current day (S12). The set amount update unit 12 performs the determination by comparing the update date with the current date. The set amount update unit 12 acquires the current date by the use of, for example, a calendar function held by the terminal device 1.

The process of S12 is a process of determining whether a point of time at which the set amount was updated belongs to a past time period (Y at S12) or to a time period including the current point of time (N at S12). Accordingly, the process slightly varies with the frequency of update of the set amount and on what type of value is stored in the time period storage unit 33 of the IC card 3. For example, in a case update of the set amount is performed not once a day but once a week and an update date is stored in the IC card 3, the set amount update unit 12 determines whether the update date belongs to the last week. In another case where, for example, update of the set amount is performed once a month and the name of a month during which the last update was performed is stored in the IC card 3, the set amount update unit 12 determines whether or not the name read from the IC card 3 is that of the last month or a month earlier than it.

If the update date is a past date (Y at S12), the set amount update unit 12 determines whether the update date is within the last time period of a predetermined length (S13). Here, the predetermined length is given by, for example, an administrator of the settlement system 4 to the terminal device 1 and the server device 2, as a parameter. For example, the predetermined time period is one year. In that case, the set amount update unit 12 determines whether the update date is within the last one year. This means that the set amount update unit 12 determines whether or not the IC card 3 just read was used for payment within the last time period of the predetermined length.

If the update date is within the last time period of the predetermined length (Y at S13), the set amount update unit 12 checks whether the ID read from the IC card 3 is registered in the gray list (S14). If not registered (N at S14), the set amount update unit 12 stores a predetermined money amount into the set amount storage unit 32 of the IC card 3 (S15). That is, the set amount update unit 12 updates the set amount stored in the IC card 3 with the predetermined money amount. The predetermined money amount is given by, for example, an administrator of the settlement system 4 to the terminal device 1 and the server device 2, as a parameter.

If the ID read from the IC card 3 is registered in the gray list (Y at S14), the set amount update unit 12 stores the value of an update value 62, in the gray list, with regard to the ID into the set amount storage unit 32 (S18). The update value 62 with regard to the ID means an update value 62 which is correlated to a list ID 61 coincident with the ID.

If the update date read from the IC card 3 is not within the last time period of the predetermined length (N at S13), the set amount update unit 12 sends an inquiry including the ID to the inquiry processing unit 24 of the server device 2 (S19), then receives a response value (S1A) and stores the response value into the set amount storage unit 32 (S1B).

After updating the set amount storage unit 32 (in S15, S18 or S1B), the set amount update unit 12 stores the current date into the date storage unit 33 of the IC card 3 (S16). In the last step, the set amount update unit 12 causes the terminal processing unit 11 to start up (S17).

If, in the step S12, the update date read from the IC card 3 is not a past date (N at S12), the set amount update unit 12 causes the terminal processing unit 11 to start up without updating the set amount (S17). It is because update of the set amount on the current day has been already performed.

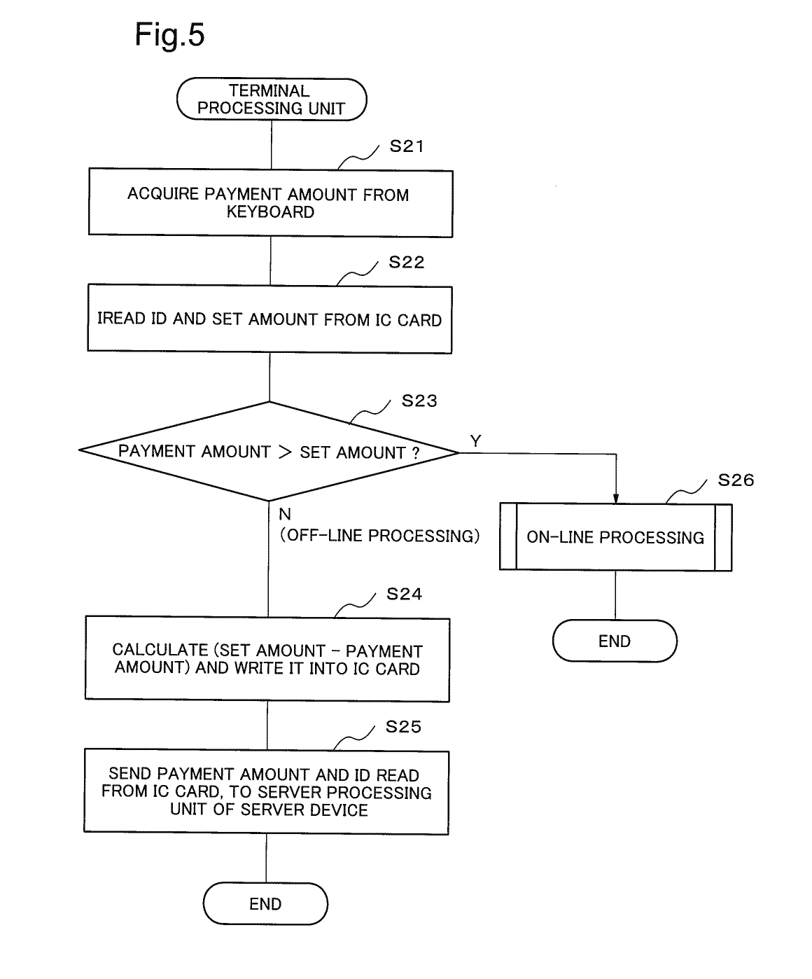

FIG. 5 is a flow chart of operation of the terminal processing unit 11. The terminal processing unit 11 acquires a payment amount from the keyboard 15 (S21), and reads the ID and the set amount from the IC card 3 (S22). The terminal processing unit 11 reads the ID and the set amount from, respectively, the ID storage unit 31 and the set amount storage unit 32.

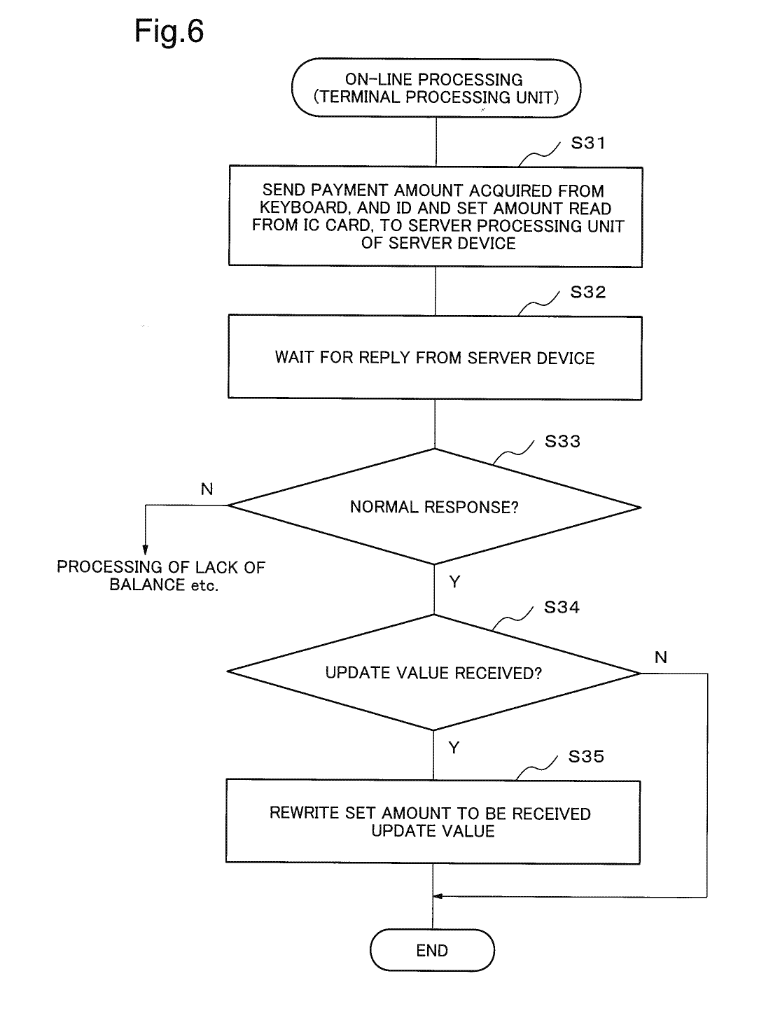

If the payment amount is larger than the set amount (Y at S23), the terminal processing unit 11 performs on-line processing (S26). This processing will be shown in FIG. 6.

If the payment amount is not larger than the set amount (N at S23), the terminal processing unit 11 performs off-line processing. Specifically, the terminal processing unit 11 calculates a value obtained by subtracting the payment amount from the set amount and stores the calculated value into the set amount storage unit 32 of the IC card 3 (S24). At this moment, determining that the payment operation has been completed for the user, the terminal processing unit 11 may permit the user to leave with the IC card 3.

After that, the terminal processing unit 11 sends the payment amount and the ID to the server processing unit 22 of the server device 2 (S25). In the case of off-line settlement, the terminal processing unit 11 does not necessarily need to wait for a response from the server device 2.

FIG. 6 is a flow chart of operation in on-line processing performed by the terminal processing unit 11.

First, the terminal processing unit 11 sends, to the server processing unit 22 of the server device 2, the payment amount inputted from the keyboard 15, the ID and the set amount read from the IC card 3 (S31), and then waits for a reply from the server device 2 (S32).

Receiving a reply from the server processing unit 22 of the server device 2, if the reply indicates normal termination of the process (Y at S33) and further includes an update value of set amount (Y at S34), the terminal processing unit 11 stores thus received update value into the set amount storage unit 32 of the IC card 3 (S35). At that moment, the terminal processing unit 11 may request the user to put the IC card 3 once again over the reader/writer 16.

If the reply from the server device 2 does not include an update value (N at S34), the second terminal processing unit 13 performs no update on the set amount storage unit 32 of the IC card 3.

If, in the step S33, a reply received from the server device 2 is one indicating abnormal termination of the process (N at S33), the terminal processing unit 13 performs a process for dealing with a cause of the abnormality. The cause of abnormality is, for example, lack of the balance 52.

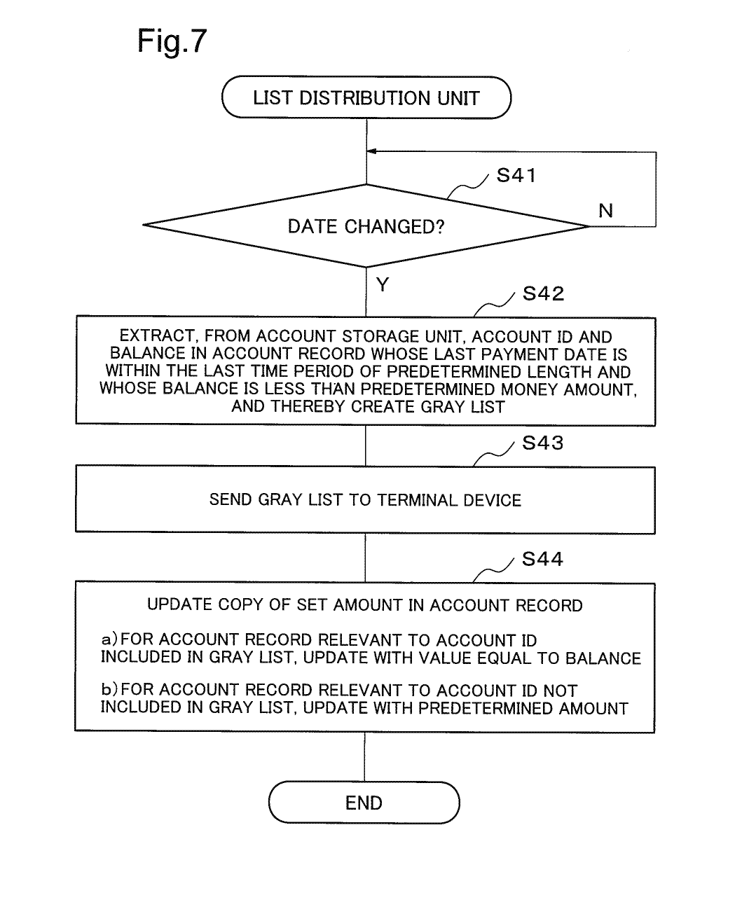

FIG. 7 is a flow chart of operation of the list distribution unit 21. The list distribution unit 21 is caused to start up, for example, once a day (S41).

When having started up, the list distribution unit 21 generates a gray list (S42). Specifically, the list distribution unit 21 extracts, from the account storage unit 25, the account ID 51 and balance 52 in an account record 50 whose last payment date 54 is within the last time period of a predetermined length and whose balance 52 is less than a predetermined money amount, and generates a gray list containing thus extracted ID and balance as, respectively, a list ID 61 and an update value 62 (S42). Then, the list distribution unit 21 sends the gray list to the terminal device 1 (S43).

In the last step, the list distribution unit 21 updates the copy of set amount 53 in each account record 50 (S44). Specifically, the list distribution unit 21 stores, as the copy of set amount 53 in each account record 50 whose account ID 51 is included in the gray list, the same value as the balance 52 of the record. As the copy of set amount 53 in each account record 50 whose account ID 51 is not included in the gray list, the list distribution unit 21 stores a predetermined money amount.

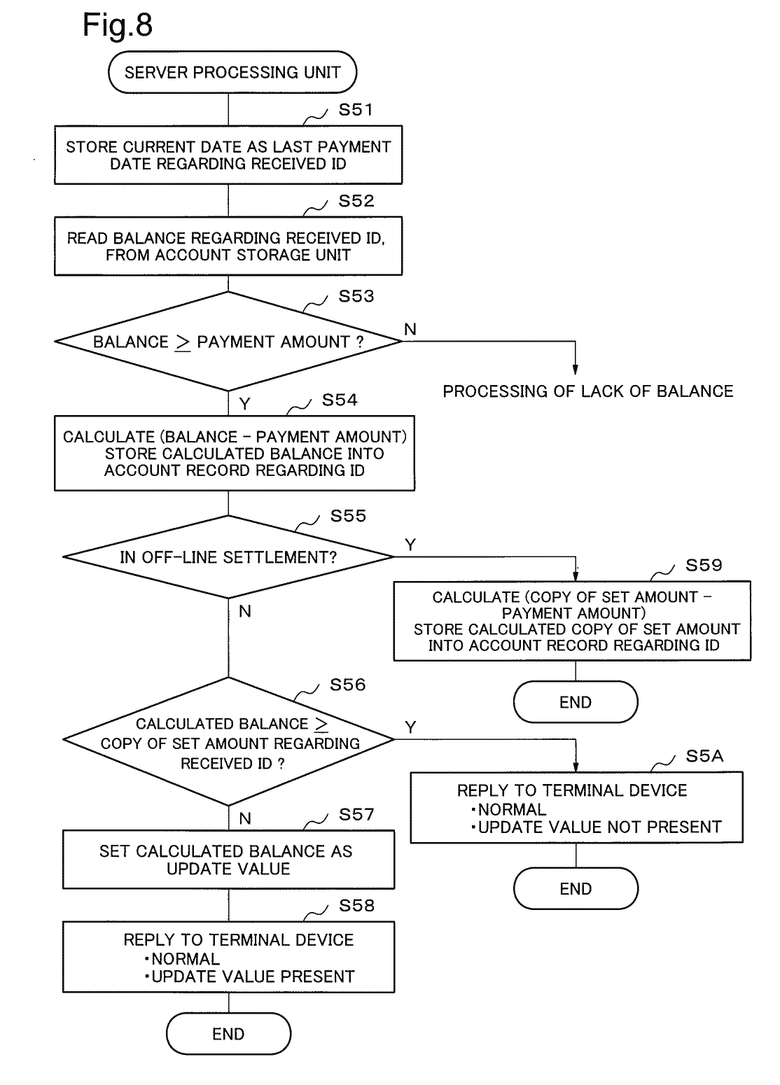

FIG. 8 is a flow chart of operation of the server processing unit 22. On receiving data on a payment amount, an ID and the like from the terminal processing unit 11 of the terminal device 1, the server processing unit 22 starts the process.

First, the server processing unit 22 stores the current date as the last payment date 54 with regard to an account ID 51 coincident with the received ID (S51). Then, the server processing unit 22 reads the balance 52 with regard to the account ID 51 coincident with the received ID, from the account storage unit 22 (S52). If confirming that the balance 52 is equal to or larger than the payment amount (Y at S53), the server processing unit 22 subtracts the payment amount from the balance 52 (S54). That is, the server processing unit 22 calculates a value obtained by subtracting the payment amount from the balance 52 and stores the calculated value into the storage unit 22 as an updated balance 52 with regard to the account ID 51 coincident with the received ID.

If the operation has been being performed in the off-line settlement (Y at S55), the server processing unit 22 subtracts the payment amount from the set amount copy 53 (S59). That is, the server processing unit 22 calculates a value obtained by subtracting the payment amount from the copy of set amount 53 and stores the calculated value into the account storage unit 22 as an updated copy of set amount 53 with regard to the account ID 51, which is coincident with the received ID. Then, the server processing unit 22 ends the process.

It is assumed that the server processing unit 22 has received information indicating which between the off-line settlement and the on-line settlement is to be performed, for example, along with the payment amount and the like, from the terminal processing unit 11.

If the operation has been being performed in the on-line settlement (N at S55), the server processing unit 22 compares the updated balance calculated in S54 and the copy of set amount 53 with regard to the account ID 51 coincident with the received ID (S56). If the calculated balance is equal to or larger than the copy of set amount 53 (Y at S56), the server processing unit 22 generates reply data showing a normal report and including no update value of the set amount and sends it to the terminal device 1 (S5A).

If the calculated balance is smaller than the copy of set amount 53 (N at S56), the server processing unit 22 sets the updated balance calculated in S54 as an update value of the set amount (S56), and generates reply data showing a normal report and including the update value and sends it to the terminal device 1 (S58).

This process is performed for the purpose of preventing an IC card 3 for an account whose balance has reduced to be less than a set amount as a result of the on-line settlement from keeping storing a set amount larger than the balance. The server processing unit 22 may use the predetermined money amount in place of the copy of set amount 53 with regard to the account ID 51 coincident with the received ID. It is because, when the predetermined money amount is used, safer determination is made in the step S56, since the maximum value of the copy of set amount 53 is equal to the predetermined money amount. The server processing unit 22 does not necessarily need to execute the steps relevant to updating the set amount stored in the IC card 3 (S56 to S58).

If the balance 52 is smaller than the payment amount (N at S53), the server processing unit 22 performs a process for dealing with the lack of balance. This process may be a process of sending, to the terminal device 1, reply data showing an abnormal report expressing settlement impossibility, and may also be a process of loaning the deficit amount.

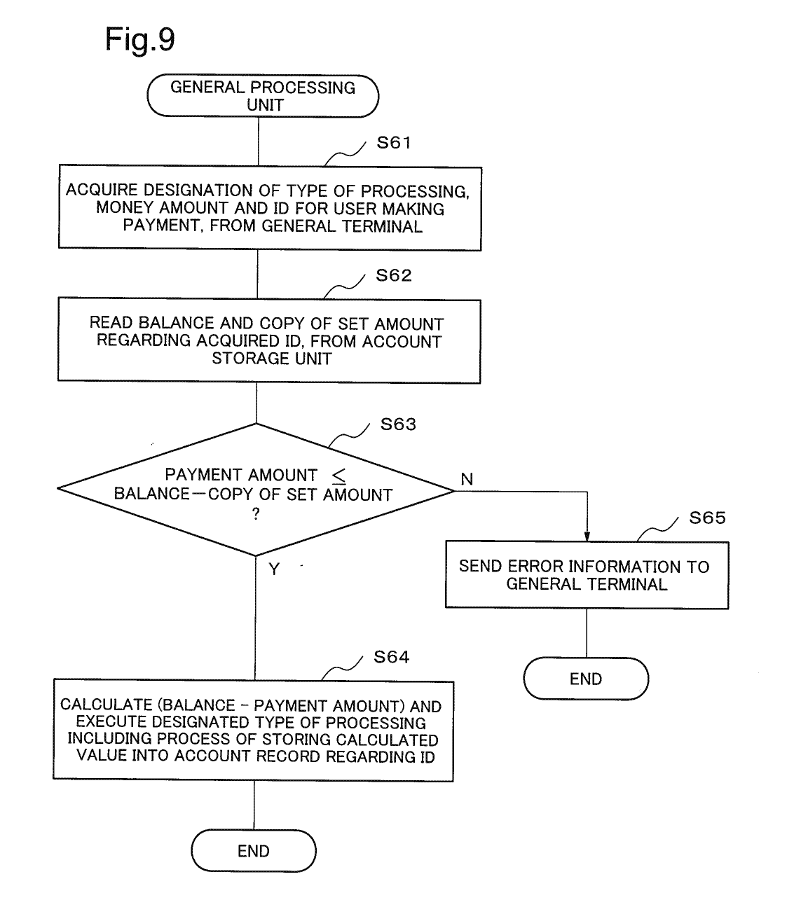

FIG. 9 is a flow chart of operation of the general processing unit 23. The general processing unit 23 performs a process for making payment without using an IC card 3. The general processing unit 23 is caused to start up when, for example, a user inputs an instruction to execute on-line settlement for money transfer to another account, payment for internet shopping or the like into the general terminal 42. The execution instruction includes designation of the type of on-line processing to be executed, an ID for the user making the payment and a payment amount. The execution instruction may include other information, for example, on a destination ID of money transfer, depending on a type of on-line processing to be executed.

In the first step, the general processing unit 23 acquires the above-described execution direction from the general terminal 42 (S61). Then, the general processing unit 23 reads, from the account storage unit 25, the balance 52 and the copy of set amount 53 with regard to an account ID 51 coincident with the acquired user ID (S62). If the acquired payment amount is equal to or smaller than an amount calculated by subtracting the copy of set amount 53 from the balance 52 (Y at S63), the general processing unit 23 executes the designated type of processing including a process of actually subtracting the payment amount from the balance 52 (S64). The actually subtracting the payment amount from the balance 52 is referred to as calculating a value by subtracting the payment amount from the balance 52 and storing the calculated value into the account storage unit 22 as an updated balance 52 with regard to the account ID 51 coincident with the acquired ID.

If the acquired payment amount is larger than an amount calculated by subtracting the copy of set amount 53 from the balance 52 (N at S63), the general processing unit 23 sends a report showing abnormal termination to the general terminal 42 (S65). That is, the general processing unit 23 executes payment operation in a manner to leave a money amount equivalent to at least the copy of set amount 53 as an updated balance 52 after completion of the execution instruction. In the step S63, the general processing unit 23 may use the predetermined money amount instead of the copy of set amount 53. In the case of using the predetermined money amount, safer determination (determination in a manner to leave a balance 52 which might be larger than the set amount) is made in the step S63, because the maximum value of the copy of set amount 53 is equal to the predetermined money amount. In the step S63, the general processing unit 23 does not necessarily need to subtract the copy of set amount 53 from the balance 52.

The inquiry processing unit 24 receives an inquiry about a set amount including an ID from the set amount update unit 12 of the terminal device 1, and sends back, as a response value, the smaller one between the balance 52 with regard to an account 51 coincident with the received ID and the predetermined money amount.

In another case where the update frequency is not once a day but once a week and is specifically, for example, every Monday, the set amount update unit 12 determines, in the step S12 of FIG. 4, whether an update date is prior to the date of the day of current processing if the day is Monday, and determines whether the update date is prior to the date of the last Monday if the day of current processing is not Monday. In still another case where the update frequency is once a month and is specifically, for example, every first day of the month, the set amount update unit 12 determines, in the step S12 of FIG. 4, whether the month represented by an update date is a month before that of the current date.

The settlement system 4 according to the present exemplary embodiment reduces the burden on users associated with charging a card with a payment means such as electronic money. It is because the set amount update unit 12 updates a set amount stored in an IC card 3 with, for example, a predetermined money amount once per almost constant time period, for example, once a day.

A user does not need to manage the remain of a set amount stored in the user's IC card 3, but needs only to put the IC card 3 over the reader/writer 16 of the terminal device 1 at least once in each of the constant time periods. Moreover, the charging is mostly performed off-line and, accordingly, the user does not need to wait for completion of on-line processing.

Furthermore, when the terminal device 1 comprises both the set amount update unit 12 and the terminal processing unit 11, the user is required to put the IC card 3 over the reader/writer 16 of the terminal device 1 only for the purpose of payment but not dedicatedly for the purpose of charging the card. Even the payment is completed only by off-line settlement if a total payment amount in the same day is within the predetermined money amount, and the user accordingly can complete both of payment and charging off-line by only a single card-putting operation.

The settlement system 4 according to the present exemplary embodiment reduces the risk associated with charging the IC card 3 with a payment means such as electronic money, which is imposed to the receiving side of payment such as a store. It is because the set amount update unit 12 does not charge the IC card 3 with a money amount exceeding the balance 52. A gray list is employed for that purpose. The gray list includes a money amount to be put into the IC card 3 for an account whose balance 52 is less than the predetermined money amount. A further reason is that the general processing unit 23 executes on-line settlement for money transfer to another account, payment for internet shopping or the like, within a money amount calculated by subtracting a money amount having been put into the IC card 3 (the copy of set amount 53 or the predetermined money amount being its maximum value) from the balance 52. A still further reason is that the server processing unit 22 prevents the IC card 3 for an account whose balance has reduced as a result of on-line settlement from keeping storing a set amount larger than the reduced balance.

The settlement system 4 according to the present exemplary embodiment can suppress the data volume of a gray list to be distributed. It is because the gray list does not include account information on an IC card 3 which has not been used for a time period equal to or longer than a predetermined one. There is only a small possibility that such an IC card 3, having not been used for a time period equal to or longer than a predetermined one, is used again in the near future. Including information on such an account in the gray list causes enlargement of the gray list, but the settlement system 4 according to the present exemplary embodiment prevents it.

### Modification of the First Exemplary Embodiment

The settlement system 4 according to the present exemplary embodiment can be applied not only to payment with electronic money based on the balance of a bank account, but also to another type of settlement, for example, payment with a credit card based on the credit balance. Further, the settlement system 4 can be used regardless of a cause of payment. A cause of payment may be payment of an equivalent money amount for commercial goods or a service, and may also be money loaning, debt repayment or simple money transfer.

The IC card 3 may be replaced by another form of IC memory or another recording medium, for example, a USB (Universal Serial Bus) memory. In that case, the reader/writer 16 is replaced by a USB interface. The IC card 3 may also be replaced, not by a thing carried by a person, but by a recording medium which is installed on the exterior of a car or on a wheelchair and is used, for example, for payment at a drive-through store.

In the first exemplary embodiment, the set amount update unit 12 stores, into the time period storage unit 33 of the IC card 3, a time-period-specifying value for specifying a time period during which the set amount storage unit 32 was updated, for example, an update date (S16 of FIG. 4). The set amount update unit 12 may store, into the time period storage unit 33 of the IC card 3, a time-period-specifying value for specifying a time period during which the set amount storage unit 32 is to be updated next time, for example, a date of the next day of the above-mentioned update date. That is, the set amount storage unit 32 may store a time-period-specifying value which specifies the time period immediately following a time period during which the last update has been performed. In that case, in the example shown in FIG. 4, the set amount storage unit 32 may read a date of the next day of an update date from the IC card 3 (S11) and accordingly determine whether the read date is that within the current time period or within a past time period (S12).

The settlement system 4 may use, as a payment amount, a set amount and a balance 52, a type of value resembling them other than a money amount, for example, the amount of points which are exchangeable for commercial goods.

Alternatively, as a payment amount, a set amount and a balance 52, the settlement system 4 may use values other than those amounts themselves but still enabling specifying them, for example, values obtained by changing their signs to be negative. In that case, the calculations described in the first exemplary embodiment are appropriately modified. For example, the magnitude relationship in comparison is reversed.

The settlement system 4 may have only a single user. In that case, the IC card 3 does not need to comprise the ID storage section 31, and the account storage unit 25 and the gray list do not need to store, respectively, any account ID 51 and any list ID 61.

The server device 2 does not necessarily need to comprise the account storage unit 25. The account storage unit 25 may be comprised in another device connected with the server device 2.

The terminal device 1 does not necessarily need to comprise the terminal processing unit 11. The terminal processing unit 11 may be comprised in a POS (Point of Sales) terminal separated from the terminal device 1. In that case, the terminal device 1 functions as a terminal being a peripheral device of the POS terminal or a so-called charging machine for electronic money or the like, and is installed in, for example, a store, a bank and a station. In that case, although a user needs to put the IC card 3 over the terminal device 1 to charge the card, the user is never bothered with the balance or determination of a money amount to add into the card.

The account record 50 does not necessarily include the copy of set amount 53. As already mentioned above, the server processing unit 22 and the general processing unit 23 may use a predetermined money amount instead of the copy of set amount 53. In that case, it becomes unnecessary for the list distribution unit 21 and the server processing unit 22 to maintain the copy of set amount 53.

The gray list may have a configuration including no update value 62. In that case, the set amount update unit 12 may acquire an update value for an account included in the gray list from the inquiry processing unit 24 of the server device 2.

The set amount update unit 12 may be configured such that it does not perform update of the set amount on the current day if it is found that, by checking the update date of the gray list, the gray list has not been normally updated. It is for the purpose of preventing writing a set amount not reflecting the latest balance 52 into the IC card 3.

The set amount update unit 12 may send data on a clock and a calendar comprised in its own device to the server device 2 and thereby verify their normality. This verification is for the purpose of detecting incorrect setting of the clock and the calendar and thereby preventing the set amount from being incorrectly updated. The verification is performed as a background process of that of updating the set amount.

When the set amount has become smaller than a threshold value as a result of the off-line processing, the terminal processing unit 11 may update the set amount to make off-line settlement able to be performed again. In that case, the terminal processing unit 11 may acquire an update amount from the inquiry processing unit 24 of the server device 2.

### Second Exemplary embodiment

The list distribution unit 21 of the server device 2 may include the account ID 51 for an account record 50 having a balance 52 less than a predetermined money amount, as a list ID 61 in the gray list, instead of including both the account ID 51 and the balance 52 for the account record 50 in the gray list. The gray list does not include any update value 62. In that case, the set amount update unit 12 of the terminal device 1 sends an inquiry about the set amount with regard to an account registered in the gray list to the inquiry processing unit 24, and updates a set amount stored in the relevant IC card 3 with a response value to the inquiry.

The gray list in the present exemplary embodiment becomes smaller in data volume compared to that in the first exemplary embodiment.

### Third Exemplary Embodiment

The list distribution unit 21 of the server device 2 may include the account ID 51 for an account record 50 having a balance 52 equal to or larger than a predetermined money amount, as a list ID 61 in the gray list, instead of including the account ID 51 and the balance 52 for an account record 50 having a balance 52 less than the predetermined money amount in the gray list. The gray list does not include any update value 62. In that case, with regard to an account registered in the gray list, the set amount update unit 12 of the terminal device 1 updates a set amount stored in the relevant IC card 3 with the predetermined money amount, and with regard to an account not registered in the gray list, the set amount update unit 12 sends an inquiry about a set amount to the inquiry processing unit 24, and updates a set amount stored in the relevant IC card 3 with a response value to the inquiry.

The gray list in the present exemplary embodiment becomes smaller in data volume compared to that in the first exemplary embodiment. This effect is significant when the number of account records 50 having a balance 52 less than a predetermined money amount is larger than the number of account records 50 having a balance 52 equal to or larger than the predetermined money amount.

### Fourth Exemplary Embodiment

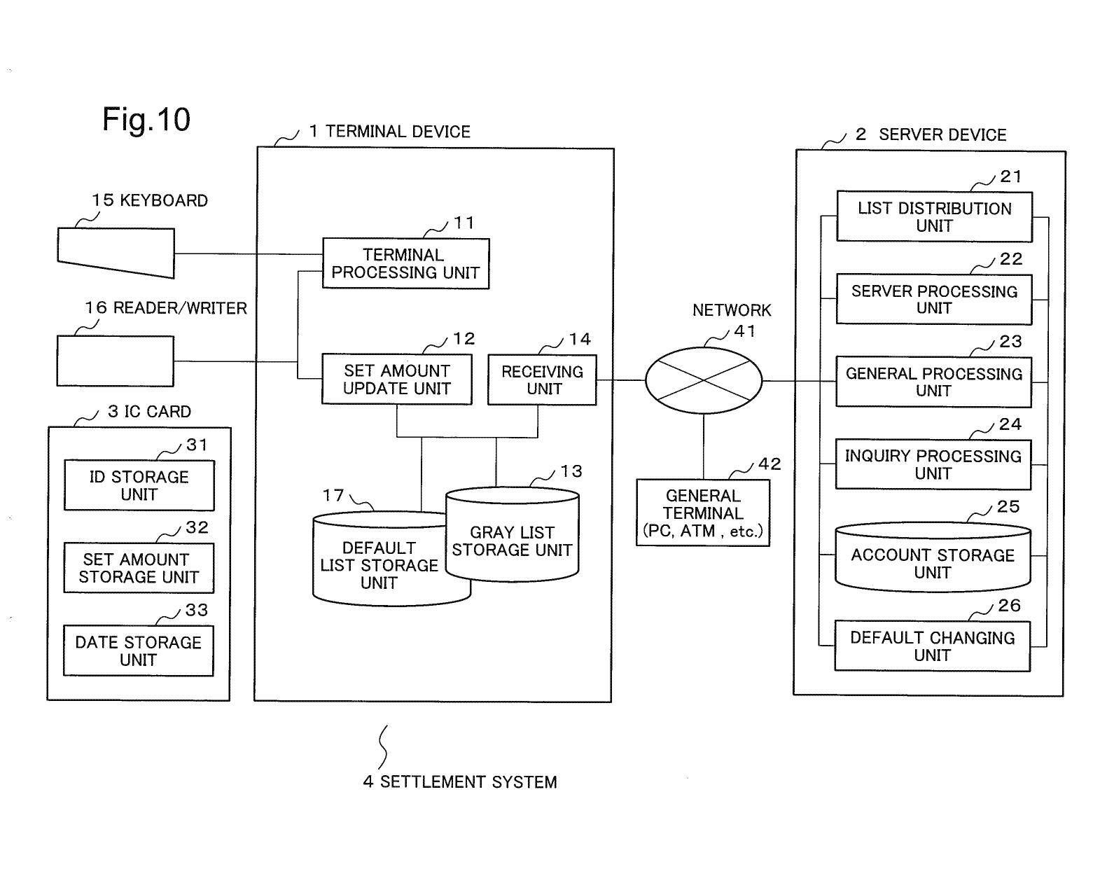

FIG. 10 is a configuration diagram of a settlement system 4 according to the present exemplary embodiment. In the first exemplary embodiment, a set amount to be stored in the IC card 3 for an account not registered in the gray list is updated with a predetermined money amount which is determined to be a constant value by the settlement system 4 (S15 in FIG. 4). In the present exemplary embodiment, a set amount of an IC card 3 is updated with a money amount which is determined to be specific to each account. Hereinafter, the difference of the present exemplary embodiment from the first exemplary embodiment will be described.

In the present exemplary embodiment, in addition to the configuration of the first exemplary embodiment, the terminal device 1 further comprises a default list storage unit 17, and the server device 2 further comprises a default changing unit 26.

The default changing unit 26 is constructed using logic circuits or the like. It may also be implemented by software which is stored in a memory (not illustrated) of the server device 2 and executed by a processor 29 of the server device 2. The default list storage unit 17 is a storage device such as an IC memory and a disk device.

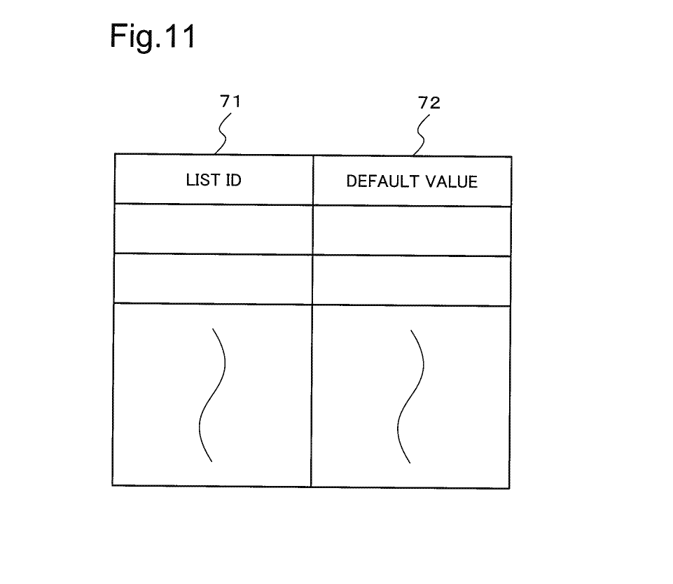

FIG. 11 shows a configuration of a default list stored in the default list storage unit 17. The default list stores a default value 72 for each ID stored as a list ID 71. The default value 72 is the above-described money amount determined to be specific to each account.

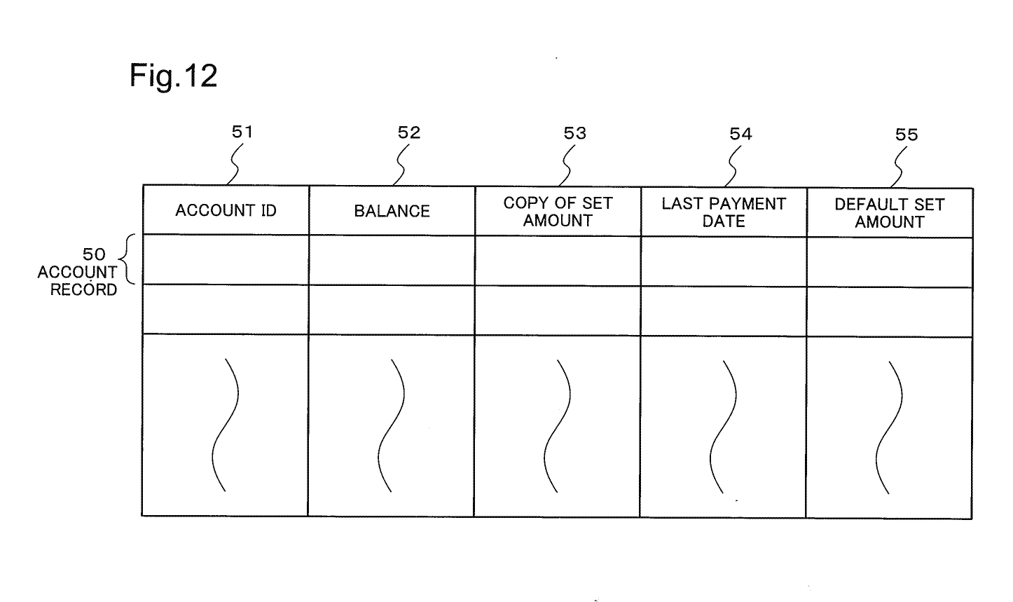

FIG. 12 shows a configuration of an account record 50 stored in the account storage unit 25 of the present exemplary embodiment. The account record 50 of the present exemplary embodiment contains a default set amount 55 in addition to the configuration in the first exemplary embodiment. An initial value of the default set amount 55 is, for example, a predetermined value determined to be a constant value by the settlement system 4. An initial value of the default set amount 55 may be a value declared in writing by the user.

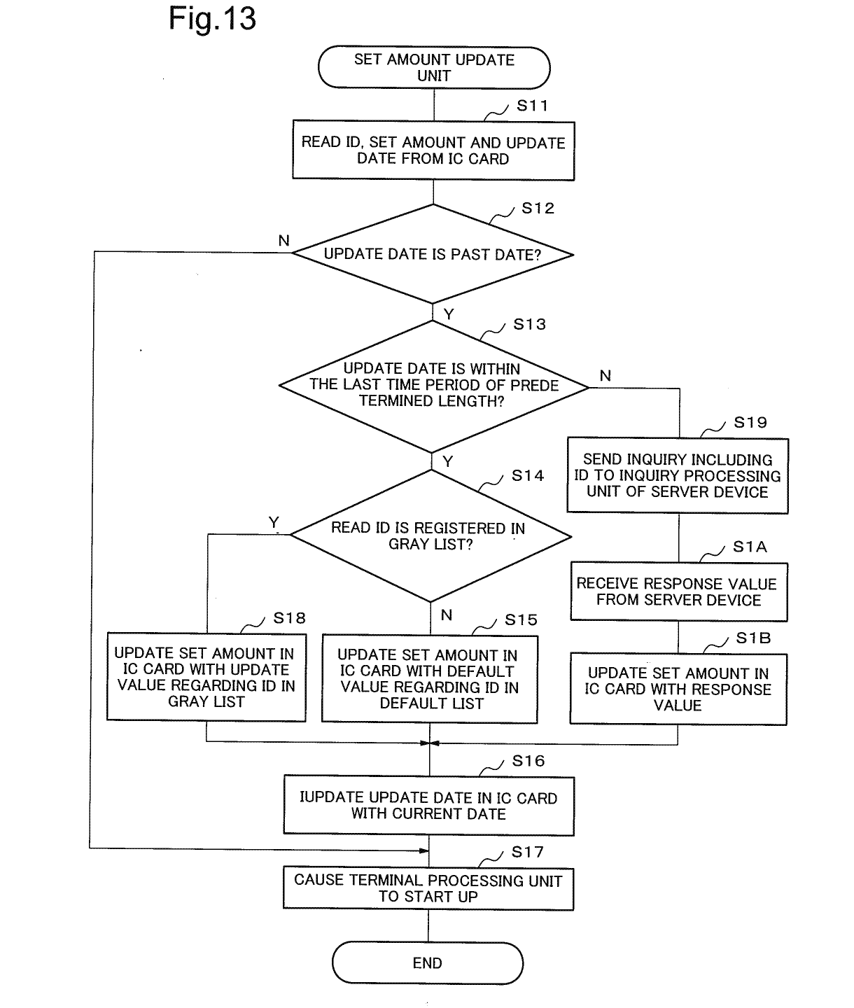

FIG. 13 is a flow chart of operation of the set amount update unit 12 in the present exemplary embodiment. In a step S15, the set amount update unit 12 in the present exemplary embodiment reads, from the default list storage unit 17, a default value 72 with regard to an ID read from an IC card 3 and stores the value into the set amount storage unit 32 of the IC card 3.

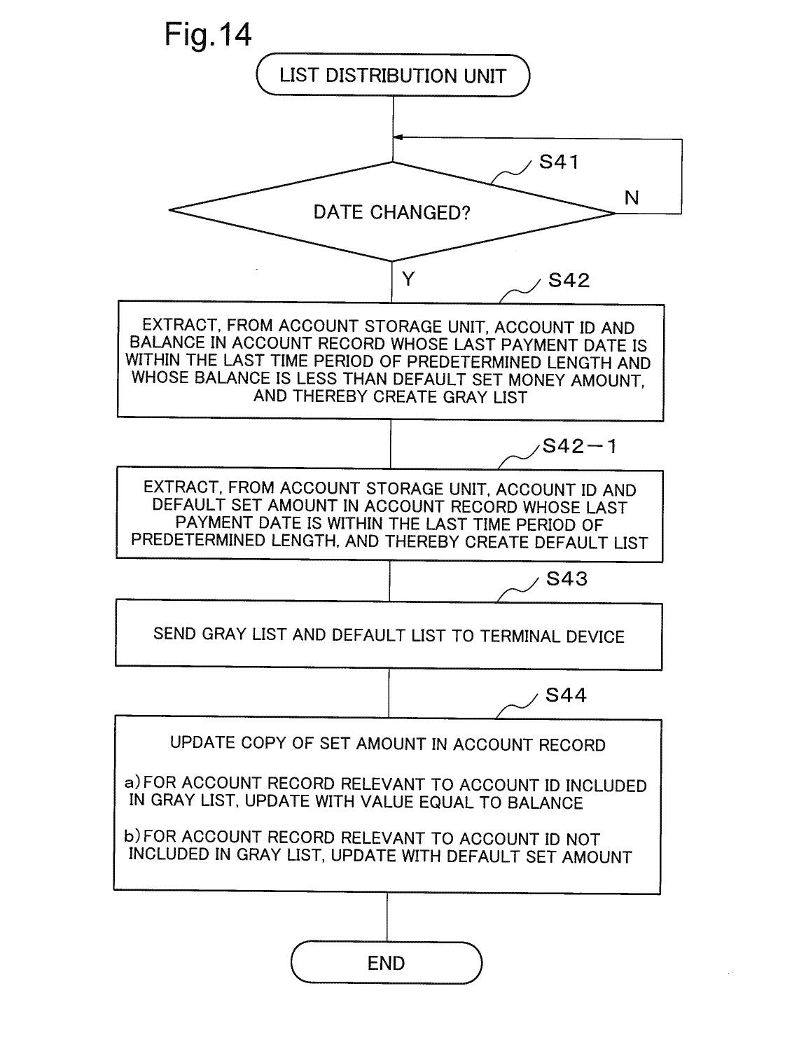

FIG. 14 is a flow chart of operation of the list distribution unit 21 in the present exemplary embodiment. In a step of generating a gray list (S42), the list distribution unit 21 in the present exemplary embodiment extracts, from the account storage unit 25, the account ID 51 and the balance 52 in an account record 50 whose last payment date 54 is within the last time period of a predetermined length and whose balance 52 is less than the default set amount 55, and generates a gray list containing thus extracted ID and balance as, respectively, a list ID 61 and an update value 62.

Subsequently, the list distribution unit 21 in the present exemplary embodiment generates a default list (S42-1). Specifically, the list distribution unit 21 extracts, from the account storage unit 25, the account ID 51 and the default set amount 55 in an account record 50 whose last payment date 54 is within the last time period of a predetermined length, and generates a default list containing thus extracted ID and default set amount as, respectively, a list ID 71 and a default value 72.

After that, the list distribution unit 21 sends also the default list along with the gray list to the terminal device 1. The receiving unit 14 of the terminal device 1 in the present exemplary embodiment receives the gray list and the default list, and then stores them into, respectively, the gray list storage unit 13 and the default list storage unit 17.

In a step of updating the copy of set amount 53 in an account record 50 (S44), the list distribution unit 21 stores the relevant default set amount 55 as an updated copy of set amount 53 in an account record 50 whose relevant account ID 51 is not included in the gray list.

When an ID and an update value are inputted from the general terminal 42, for example, the default changing unit 26 rewrites the default set amount 55 in an account record 50 with regard to the ID with the update value.

In the settlement system 4 of the present exemplary embodiment, it becomes possible to change a money amount stored in an IC card in accordance with the individual needs and economic condition of each user. A temporary change also becomes possible. For example, a user willing to use whole of the balance 52 for web settlement needs only to set the default set amount 55 at zero on the previous day.

The reason of giving such an effect is that the server device 2 holds a default set amount 55 for each ID and sends the set amount almost periodically to the terminal device 1 by including it in the default list. The reason is also that, on the basis of the default list, the terminal device 1 then stores a set amount into an IC card 3.

### Fifth Exemplary Embodiment

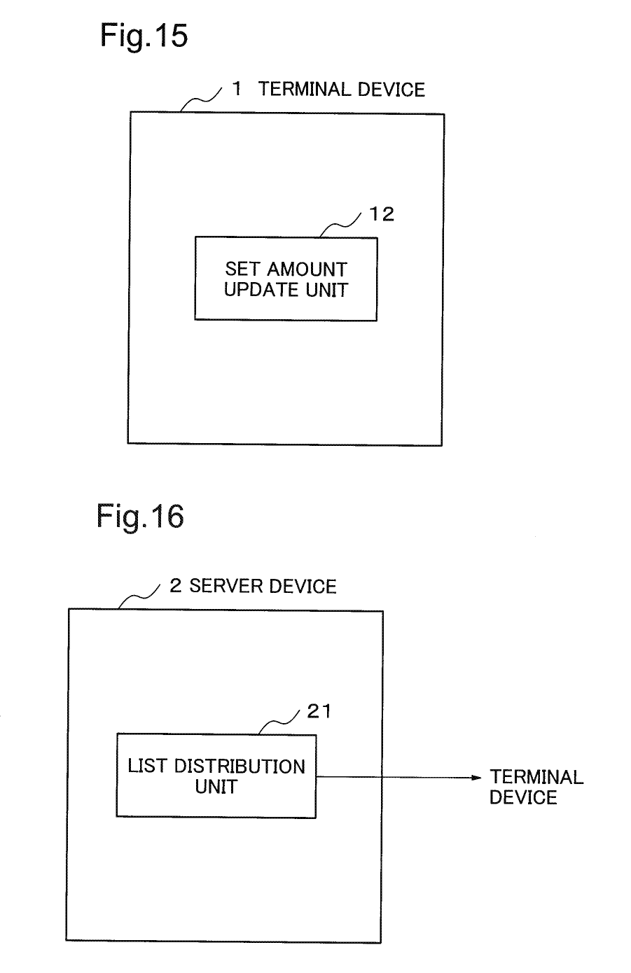

FIG. 15 shows a configuration of a terminal device 1 in the present exemplary embodiment. The terminal device 1 in the present exemplary embodiment comprises a set amount update unit 12.

The set amount update unit 12 performs a process of reading a time-period-specifying value, which is a value specifying any one of a plurality of time periods, from a recording medium, for example, an IC card 3, storing the time-period-specifying value and a set amount, which is a value specifying a payable money amount. If the read time-period-specifying value is specifying a predetermined time period, the set amount update unit 12 further performs a process of updating the set amount stored in the recording media and a process of updating the time-period-specifying value stored in the recording medium with a value specifying a time period equal to or later than that immediately following the predetermined time period.

The terminal device 1 according to the present exemplary embodiment reduces the burden on a user associated with charging an IC card with a payment means such as electronic money. It is because the set amount update unit 12 updates a set amount stored in an IC card 3 once per certain time period, for example, once a day.

A user does not need to manage the remain of the set amount stored in the user's IC card 3, but needs only to put the IC card 3 over the reader/writer 16 of the terminal device 1 at least once in each of constant time periods.

### Sixth Exemplary Embodiment

FIG. 16 shows a configuration of a server device 2 in the present exemplary embodiment. The server device 2 is connected with a terminal device and comprises a list distribution unit 21.

The terminal device performs: a process of receiving a gray list including an update amount with regard to a recording medium, for example, an IC card 3, storing a set amount, which is a value specifying a payable money amount, and a time-period-specifying value, which is a value specifying any one of a plurality of time periods; a process of reading the time-period-specifying value from the recording medium; and if the read time-period-specifying value is specifying a predetermined time period, a process of searching the gray list, a process of updating the set amount stored in the recording medium and a process of updating the time-period-specifying value stored in the recording medium with a value specifying a time period equal to or later than that immediately following the predetermined time period.

The process of updating a set amount stored in a recording medium is a process of updating with an update value with regard to the recording medium if the update value is included in the gray list, and with a predetermined money amount if not included.

In each of the time periods, the list distribution unit 21 generates a gray list including the balance of an account, with regard to a recording medium, whose balance is less than the predetermined money amount and sends the gray list to the terminal device.

The server device 2 according to the present exemplary embodiment reduces the burden on a user associated with charging an IC card with a payment means such as electronic money and also reduces risk to the payment receiving side such as a store. It is because the list distribution unit 21 distributes a gray list once per certain time period, for example, once a day, and the terminal device updates, in each of the time periods, a set amount stored in an IC card 3 with a predetermined money amount or with a value based on the gray list.

### Seventh Exemplary Embodiment

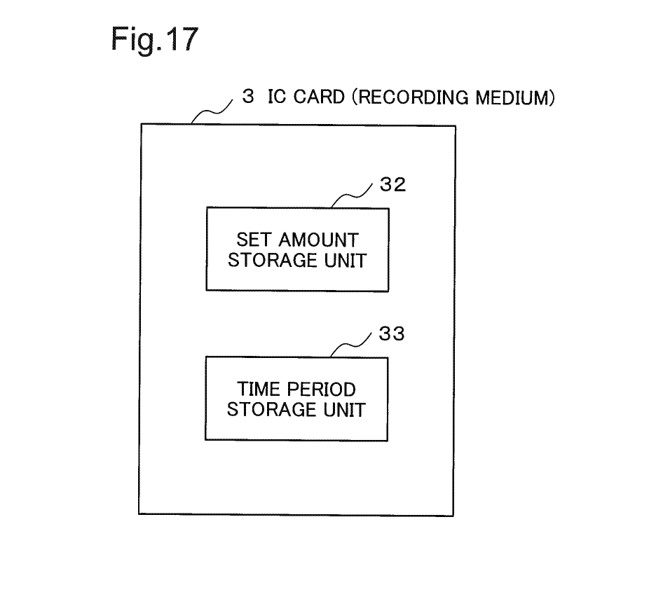

FIG. 17 shows a configuration of a recording medium, for example, an IC card 3, in the present exemplary embodiment. The IC card 3 comprises a set amount storage unit 32 for storing a set amount, which is a value specifying a payable money amount, and a time period storage unit 33 for storing a time-period-specifying value, which is a value specifying any one of a plurality of time periods.

This IC card 3 is configured such that, if the time-period-specifying value stored in the time period storage unit 33 specifies a predetermined time period, the set amount stored in the set amount storage unit 32 is updated, and the time-period-specifying value stored in the time period storage unit 33 is updated with a value specifying a time period equal to or later than that immediately following the predetermined time period.

The recording medium, for example, the IC card 3, according to the present exemplary embodiment reduces the burden on a user associated with charging an IC card with a payment means such as electronic money. It is because the set amount stored in the set amount storage unit 32 is updated once per certain time period, for example, once a day.

The present invention has been described above with reference to the exemplary embodiments, but the present invention is not limited to the above-described exemplary embodiments. To the configurations and details of the present invention, various changes and modifications which can be understood by those skilled in the art may be made within the scope of the present invention.

### REFERENCE LIST

1 terminal device

2 server device

3 C card

4 settlement system

11 terminal processing unit

12 set amount update unit

13 gray list storage unit

14 receiving unit

15 keyboard

16 reader/writer

17 default list storage unit

19, 29 processor

21 list distribution unit

22 server processing unit

23 general processing unit

24 inquiry processing unit

25 account storage unit

26 default changing unit

31 ID storage unit

32 set amount storage unit

33 date storage unit

33 time period storage unit

41 network

42 general terminal

51 account ID

52 balance

53 copy of set amount

54 last payment date

55 default set amount

61,71 list ID

62 update value

72 default value

1-3. (canceled)

4. A terminal device comprising:
a set amount update unit that:
performs a process of reading a time-period-specifying value, which is a value specifying any one of a plurality of time periods, from a recording medium storing the time-period-specifying value and a set amount, which is a value specifying a payable money amount,
performs, if the read time-period-specifying value is specifying a predetermined time period,
a process of updating the set amount stored in the recording medium, and
a process of updating the time-period-specifying value stored in the recording medium with a value specifying a time period equal to or later than that immediately following the predetermined time period; and
a gray list storage unit that stores a gray list including an update amount with regard to the recording medium, wherein the set amount update unit performs:
a process of searching the gray list, and
a process of updating the set amount with an update value with regard to the recording medium if the update value is included in the gray list, and with a predetermined money amount if no update value is included in the gray list.

5. A settlement system comprising:
a server device including list distribution unit that performs
a process of generating, in each of the time periods, the gray list including the balance of an account, with regard to the recording medium, whose the balance is less than the predetermined money amount and
a process of sending the gray list to the terminal device, and
the terminal device according to claim 4 further including a receiving unit that performs
a process of receiving the gray list and
a process of storing it into the gray list storage unit.

6. The settlement system according to claim 5, wherein:
the terminal device further comprises a terminal processing unit that compares a payment amount with the set amount and performing, depending on a result of the comparison,
off-line processing including a process of subtracting the payment amount from the set amount and a process of sending the payment amount to the server device or
on-line processing including a process of sending the payment amount to the server device and a process of waiting for a completion report from the server device,
and
the server device further comprises a server processing unit that
performs a process of subtracting the payment amount from the balance of the account with regard to the recording medium and
performs, in a case of the on-line processing, a process of sending a completion notification to the terminal device.

7. The settlement system according to claim 6, wherein:
in a case of the on-line processing, if the balance after subtracting the payment amount from it is less than the predetermined money amount, the server processing unit of the server device sends the balance after subtracting the payment amount from it, as an update value, to the terminal device, and
in the case of the on-line processing, the terminal processing unit of the terminal device performs a process of receiving the update value and a process of updating the set amount with the update value.

8. The settlement system according to claim 6, wherein the server device further comprises a general processing unit that:
performs a process of acquiring, from a general terminal device, a request for performing a process, the request including a money amount to be processed, and
performs a process of rejecting the request for performing a process if a value calculated by subtracting the predetermined money amount from the balance of the account is less than the money amount to be processed, and if not,
performs the requested process including subtracting the money amount to be processed from the balance of the account.

9. The settlement system according to claim 6, wherein:
at a time of communication with the terminal device performing the on-line processing or the off-line processing, the server processing unit stores the date of the communication as a last payment date into the recording medium,
the gray list distribution unit generates the gray list including the balance of the account whose the last payment date is within the last time period of a predetermined length and whose the balance is less than the predetermined money amount,
if a time period specified by the time-period-specifying value is not within the last time period of a predetermined length, the set amount update unit performs a process of sending an inquiry about a set amount to the server device, a process of receiving a response value and a process of updating the set amount with the response value, and
the server device further comprises an inquiry processing unit that performs a process of receiving the inquiry about a set amount from the terminal device and a process of replying it by setting, as the response value, the smaller one between the predetermined money amount and the balance of the account with regard to the recording medium.

10. (canceled)

11. A terminal device comprising:
a set amount update unit that:
performs a process of reading a time-period-specifying value, which is a value specifying any one of a plurality of time periods, from a recording medium storing the time-period-specifying value and a set amount, which is a value specifying a payable money amount, and
performs, if the read time-period-specifying value is specifying a predetermined time period,
a process of updating the set amount stored in the recording medium, and
a process of updating the time-period-specifying value stored in the recording medium with a value specifying a time period equal to or later than that immediately following the predetermined time period; and
a default list storage unit that stores a default list including a default money amount with regard to each of identifiers stored by respective ones of a plurality of the recording media;
a gray list storage unit that stores gray list including the update amount with regard to each of the identifiers of the recording media, wherein
the set amount update unit performs:
a process of reading the identifier stored in the recording medium and then searching the default list,
a process of updating the set amount in the recording medium from which the identifier was read, with the default money amount with regard to the identifier
a process of reading the identifier stored in the recording medium and then searching the gray list, and
a process of updating, if the identifier is included in the gray list, the set amount in the recording medium from which the identifier was read, with the update amount with regard to the identifier in the gray list.

12. A settlement system comprising:
a server device comprising list distribution unit that performs, in each of time periods,
a process of searching account information including a balance and the default money amount, with regard to each of the identifiers of respective ones of the plurality of recording media,
a process of generating the gray list including the identifier and the balance contained in the account information whose the balance is less than the default money amount and generating also the default list including the identifier and the default money amount contained in the account information, and
a process of sending the gray list and the default list to the terminal device,
and
the terminal device according to claim 11, further comprising a receiving unit that performs
a process of receiving the gray list and the default list and
a process of storing them into, respectively, the gray list storage unit and the default list storage unit.

13. (canceled)

14. A settlement system comprising:
a server device comprising list distribution unit that performs, in each of the time periods,
a process of searching account information containing a balance with regard to each of the identifiers of respective ones of the plurality of recording media,
a process of generating the gray list including the identifier contained in the account information whose the balance is equal to or larger than the predetermined money amount, and a process of sending the gray list to the terminal device; and
the terminal device according to claim 13, further comprising a receiving unit that receives the gray list and then storing it into the gray list storage unit.

15. A server device connected to a terminal device, the terminal device performs:
a process of receiving a gray list including an update amount with regard to a recording medium storing a set amount, which is a value specifying a payable money amount, and a time-period-specifying value, which is a value specifying any one of a plurality of time periods, and a process of reading the time-period-specifying value from the recording medium, and
if the read time-period-specifying value is specifying a predetermined time period,
a process of searching the gray list,
a process of updating the set amount stored in the recording medium with the update value with regard to the recording medium if the update value is included in the gray list and, if not included, with a predetermined money amount and
a process of updating the time-period-specifying value stored in the recording medium with a value specifying a time period equal to or later than that immediately following the predetermined time period,
the server device comprising list distribution unit that performs, in each of the time periods,
a process of generating the gray list including the balance of the account, with regard to the recording medium, whose the balance is less than the predetermined money amount, and
a process of sending the gray list to the terminal device.

16-19. (canceled)

20. A method comprising;
performing a process of reading a time-period-specifying value, which is a value specifying any one of a plurality of time periods, from a recording medium storing the time-period-specifying value and a set amount, which is a value specifying a payable money amount;
performing, if the read time-period-specifying value is specifying a predetermined time period, a process of updating the set amount stored in the recording medium and a process of updating the time-period-specifying value stored in the recording medium with a value specifying a time period equal to or later than that immediately following the predetermined time period
performing a process of storing a gray list including an update amount with regard to the recording medium; and
performing a process of searching the gray list, and a process of updating the set amount with the update value with regard to the recording medium if the update value is included in the gray list and, if not included, with a predetermined money amount.

21. (canceled)

22. A method comprising;
performing a process of reading a time-period-specifying value, which is a value specifying any one of a plurality of time periods, from a recording medium storing the time-period-specifying value and a set amount, which is a value specifying a payable money amount;
performing, if the read time-period-specifying value is specifying a predetermined time period, a process of updating the set amount stored in the recording medium and a process of updating the time-period-specifying value stored in the recording medium with a value specifying a time period equal to or later than that immediately following the predetermined time period
performing a process of storing a default list including a default money amount with regard to each of identifiers stored in respective ones of a plurality of the recording media;
performing a process of reading the identifier stored in the recording medium and then searching the default list; and
performing a process of updating the set amount stored in the recording medium from which the identifier was read, with the default money amount with regard to the identifier:
performing a process of storing a gray list including the update amount with regard to the identifier of the recording medium;
performing a process of reading the identifier stored in the recording medium and then searching the gray list; and
performing, if the identifier is included in the gray list, a process of updating the set amount stored in the recording medium from which the identifier was read, with the update amount with regard to the identifier.

23. (canceled)

24. A method comprising:
performing a process of connecting to a terminal device which performs
a process of receiving a gray list including an update amount with regard to a recording medium storing a set amount, which is a value specifying a payable money amount, and a time-period-specifying value, which is a value specifying any one of a plurality of time periods, and a process of reading the time-period-specifying value from the recording medium, and
if the read time-period-specifying value is specifying a predetermined time period, performs
a process of searching the gray list,
a process of updating the set amount stored in the recording medium with the update value with regard to the recording medium if the update value is included in the gray list and, if not included, with a predetermined money amount, and
a process of updating the time-period-specifying value stored in the recording medium with a value specifying a time period equal to or later than that immediately following the predetermined time period;
and
performing, in each of the time periods, a process of generating the gray list including the balance of an account, with regard to the recording medium, whose the balance is less than the predetermined money amount, and sending the gray list to the terminal device.

25-27. (canceled)

28. The non-transitory computer-readable storage medium according to claim 25, for causing the computer to execute:
a process of storing a gray list including an update amount with regard to the recording medium;
a process of searching the gray list; and
a process of updating the set amount with the update value with regard to the recording medium if the update value is included in the gray list and, if not included, with a predetermined money amount.

29. (canceled)

30. A non-transitory computer-readable storage medium storing a program for causing a computer to execute:
a process of reading a time-period-specifying value, which is a value specifying any one of a plurality of time periods, from a recording medium storing the time-period-specifying value and a set amount, which is a value specifying a payable money amount:
if the read time-period-specifying value is specifying a predetermined time period a process of updating the set amount stored in the recording medium and a process of updating the time-period-specifying value stored in the recording medium with a value specifying a time period equal to or later than that immediately following the predetermined time period
a process of storing a default list including a default money amount with regard to each of identifiers stored in respective ones of a plurality of the recording media
a process of reading the identifier stored in the recording medium and the searching the default list; and
a process of updating the set amount stored in the recording medium from which the identifier was read, with the default money amount with regard to the identifier;
a process of storing a gray list including the update amount with regard to the identifier of the recording medium;
a process of reading the identifier stored in the recording medium and then searching the gray list; and
a process of updating, if the identifier is included in the gray list, the set amount stored in the recording medium from which the identifier was read, with the update amount with regard to the identifier.

31. (canceled)

32. A non-transitory computer-readable storage medium storing a program for causing a computer to execute:
a process of connecting to a terminal device which performs a process of receiving a gray list including an update amount with regard to a recording medium storing a set amount, which is a value specifying a payable money amount, and a time-period-specifying value, which is a value specifying any one of a plurality of time periods, and a process of reading the time-period-specifying value from the recording medium, and,
if the read time-period-specifying value is specifying a predetermined time period,
performs a process of searching the gray list, a process of updating the set amount stored in the recording medium with the update value with regard to the recording medium if the update value is included in the gray list and, if not included, with a predetermined money amount, and
a process of updating the time-period-specifying value stored in the recording medium with a value specifying a time period equal to or later than that immediately following the predetermined time period; and
a process of generating, in each of the time periods, the gray list including the balance of the account, with regard to the recording medium, whose the balance is less than the predetermined money amount, and sending the gray list to the terminal device.
